(19) United States
(12) Patent Application Publication
(10) Pub. No.: US 2003/0109941 A1
(43) Pub. Date: Jun. 12, 2003

(54) N-mode control method and device

(75) Inventor: Richard J. Thomas, Kettering, OH (US)

Correspondence Address: DELPHI TECHNOLOGIES, INC., 1450 W. Long Lake, P.O. BOX 5052, Mail Code: 482-204-450, Troy, MI, 48098, US

(73) Assignee: DELPHI TECHNOLOGIES INC.

(21) Appl. No.: 10/014,083

(22) Filed: Dec. 11, 2001

(51) Int. Cl. G05B 19/18; G05B 11/01; G05B 13/02; G05B 9/02

(52) U.S. Cl. 700/78; 700/79; 700/2; 700/19

(57) ABSTRACT

A N-mode control method for providing an input control signal to control an output of a plant is disclosed. First, one or more error control signals and one or more output control signals are determined. Each error control signal is a function of one or more error output signals with each error output signal being indicative a differential between one or more measured output signals of the plant and one or more commanded output signals of the plant. Each output control signal is as a function of the one or more measured output signals. Second, the input control signal is determined as a function of a N dynamics control law when the error control signal(s) and the output control signal(s) collectively indicate the plant is operating in a 1^{st} or 2_{nd} or 3_{rd} or . . . (N−1)^{th} or N^{th} region of operation.

### BACKGROUND OF THE INVENTION

1. Field of the Invention

The present invention generally relates to controllers and associated control methods. The present invention particularly relates to an optimization of a control method in view of a fixed design of a plant operating as a single input-single output system (“SISO”), a single input-multiple output system (“SIMO”), a multiple input-single output system (“MISO”) or a multiple input-multiple output system (“MIMO”).

2. Description of the Related Art

A common set of desired operational characteristics for an output signal of a plant is a rapid reduction in large errors, a rapid decay of steady-state errors, and a minimization of an overshoot. When a design of the plant is fixed, a controller for providing an input control signal to the plant is designed in an attempt to achieve each goal. Typically, an achievement of one operational characteristic results in a failure to achieve one or more of the other operational characteristics. The present invention solves this problem.

### SUMMARY OF THE INVENTION

The present invention relates to a method and device for obtaining an optimal control algorithm that overcomes the aforementioned disadvantages of the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for providing an input control signal to a plant. First, one or more error control signals, and one or more output control signals are determined. Each error control signal is a function of one or more error output signals, with each error output signal being indicative of a differential between one or more commanded output signals of the plant and one or more measured output signals of the plant. Each output control signal is a function of the one or more measured output signals. Second, the input control signal is determined as a function of a first dynamics control law when the error control signal(s) and the output control signal(s) collectively indicate the plant is operating in a first region of operation. Or, the input control signal is determined as a function of a second dynamics control law when the error control signal(s) and the output control signal(s) collectively indicate the plant is operating in a second region of operation.

The foregoing form, and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a closed loop feedback system in accordance with the present invention;

FIG. 2 illustrates a flow chart representative of one embodiment of a dual mode control method in accordance with the present invention;

FIG. 3 illustrates a flow chart representative of a first embodiment of a system dynamics determination method in accordance with the present invention;

FIG. 4 illustrates a flow chart representative of a second embodiment of a system dynamics determination method in accordance with the present invention;

FIG. 5 illustrates a flow chart representative of a second embodiment of a tri-mode control method in accordance with the present invention;

FIG. 6 illustrates a flow chart representative of a third embodiment of a system dynamics determination method in accordance with the present invention; and

FIG. 7 illustrates an exemplary operation of the closed-loop feedback system of FIG. 1.

### DETAILED DESCRIPTION OF THE PRESENTLY PREFERRED EMBODIMENTS

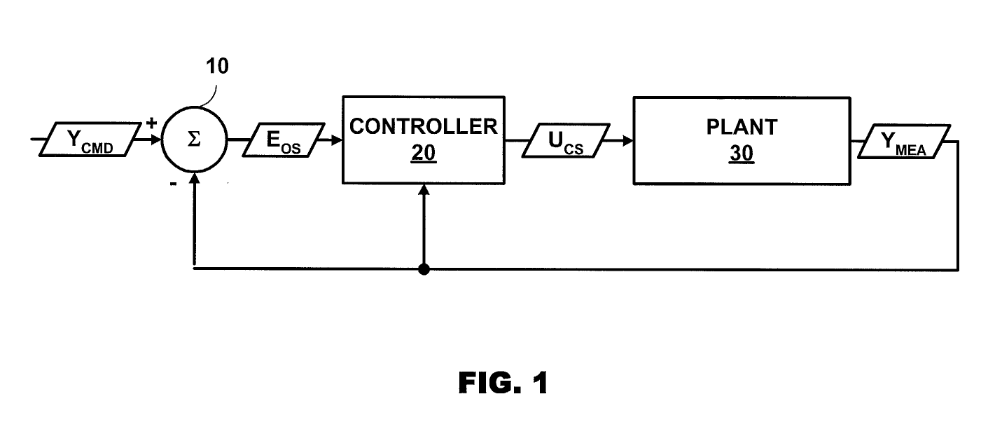

FIG. 1 illustrates a closed loop control system in accordance with the present invention. A plant 30 is any type of controllable system for providing one or more controlled outputs in response to a reception of one or more input control signals (e.g., a SISO, a SIMO, a MISO, and a MIMO). Specific examples of plant 30 include, but are not limited to, an electromechanical brake caliper for an automobile, an electro hydraulic caliper for an automobile, electromechanical fluid accumulator, an automated lathe machine, or an automated oxygen-acetylene metal cutting machine.

A controller 20 provides an input control signal Ucs to plant 30 in response to a reception of a measured output signal Y_{MEA} from plant 30 and an error output signal Eₒₛ from a summer 10. Summer 10 provides error output signal E_{OS} as a differential of a commanded output signal Y_{CMD} and the measured output signal Y_{MEA}. Input control signal U_{CS}, error output signal E_{OS}, commanded output signal Y_{CMD}, and measured output signal Y_{MEA} can be in the form of single value signals or vector signals. In alternative embodiments, controller 20 can provide additional input control signals (not shown) to plant 30 in response to a reception of measured output signal Y_{MEA} and any additional measured output signals (not shown), and error output signal E_{OS} any additional error output signals (not shown). Also, summer 10 can provide error output signal E_{OS} and any additional error output signals with each error output signal being a indifferential of commanded output signal Y_{CMD} and any additional commanded output signals (not show) and measured output signal Y_{MEA} and additional measured output signals.

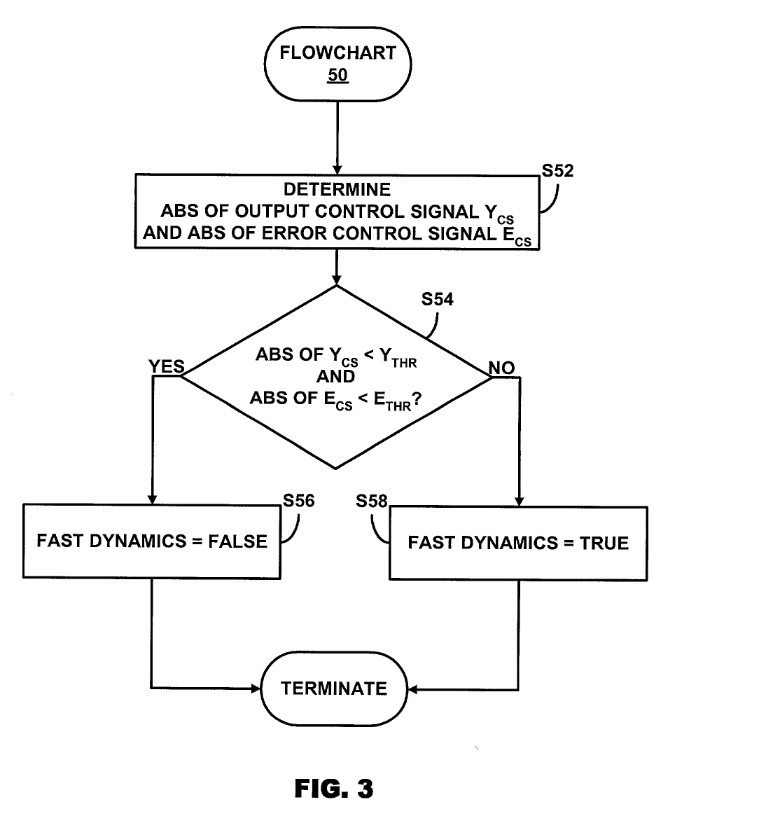

Controller 20 is operated to provide input control signal U_{CS} and any additional input control signals as a function of a N control dynamics law when error control signal E_{CS} and any additional error control signals, and an output control signal Y_{CS} (FIG. 3) and any additional output control signals indicate plant 30 is operating in a N region of operation. The result is an equalization of commanded output signal Y_{CMD} and any additional commanded output signals (not show) to corresponding measured output signal Y_{MEA} and additional corresponding measured output signals.

In a first embodiment, controller 20 is comprised of digital circuitry, analog circuitry, or both for implementing one or more N-mode control methods of the present invention. In a second embodiment, controller 20 is programmable, a dedicated state machine, or a hybrid combination of programmable and dedicated hardware for implementing the dual mode control methods of the present invention. In a third embodiment, controller 20 includes an integrated processing unit operatively coupled to one or more solid-state memory devices containing programming corresponding to one or more of the dual mode control methods of the present invention. With each embodiment, controller 20 consists of either one unit or several units distributed throughout the system. To implement the principals of the present invention, each embodiment of controller 20 can further include any control clocks, interfaces, signal conditioners, filters, Analog-to-Digital (A/D) converters, Digital-to-Analog (D/A) converters, communication ports, or other types of operators as would occur to those having ordinary skill in the art. Additionally, summer 10 may be incorporated within an embodiment of controller 20.

To facilitate an understanding of the principles of the present invention, both a dual mode control method of the present invention and a tri-mode control method of the present invention will be described herein with plant 30 being operated as a SISO. From these descriptions, those having ordinary skill in the art will appreciate embodiments of control methods of the present invention having four (4) modes or higher. Those having ordinary skill in the art will further appreciate the implementation of alternative embodiments of the dual mode control method and the tri-mode control methods as well as other N-mode control methods of the present invention relative to plant 30 operating as a SIMO, a MISO, and a MIMO.

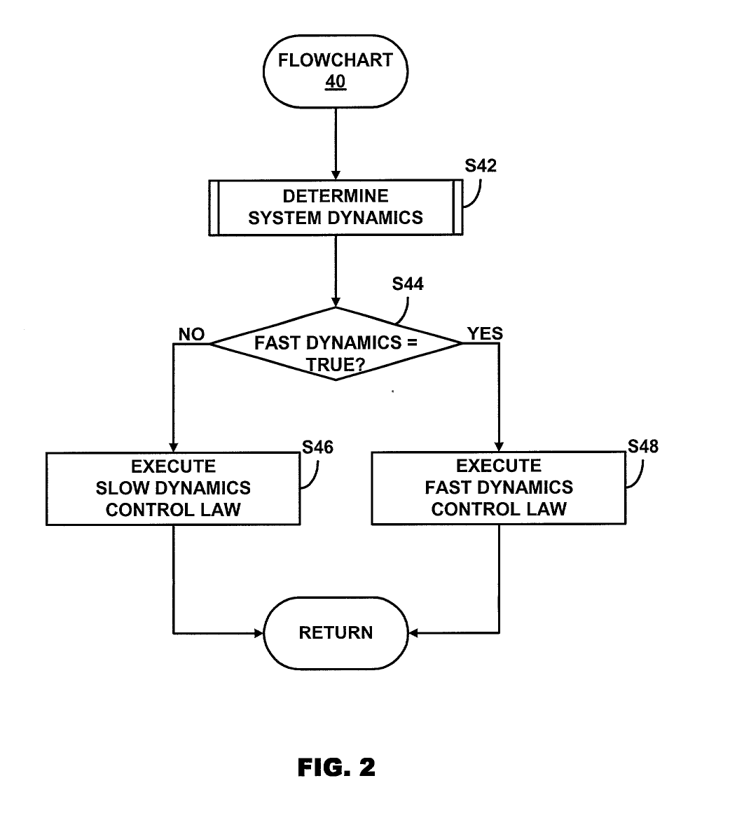

FIG. 2 illustrates a flowchart 40 as a representation of a first embodiment of a dual mode control method of the present invention. During stage S42 of the flowchart 40, controller 20 determines a system dynamics of plant 30 (FIG. 1). In one embodiment, controller 20 executes a flowchart 50 as illustrated in FIG. 3 during stage S42. Flowchart 50 is representative of a first embodiment of a method of determining a system dynamics of plant 30 in accordance with the present invention.

During a stage S52 of flowchart 50, controller 20 determines an absolute value (“ABS”) of output control signal Y_{CS} and the ABS of error control signal E_{CS}. In a first embodiment, controller 20 determines the ABS of output control signal Y_{CS} as an ABS of a derivative of measured output signal Y_{MEA} over a time period X, and controller 20 determines error control signal E_{CS} as an ABS of error output signal E_{OS} over time period X. In a second embodiment, controller 20 determines the ABS of output control signal Y_{CS} as a vector of Z elements of previously stored inputs of ABS of measured output signal Y_{MEA} over time period X, and controller 20 determines the ABS of error control signal E_{CS} as a vector of Z elements of previously stored inputs of ABS of error output signal E_{OS} over time period X. Those having ordinary skill in the art will appreciate other embodiments for determining the ABS of output control signal Y_{CS} and the ABS of error control signal E_{CS}.

During a stage S54 of flowchart 50, controller 20 ascertains whether the ABS of the output control signal Y_{CS} is less than an output control threshold Y_{THR} and whether the ABS of error control signal E_{CS} is less than an error threshold E_{THR}. This determination is straightforward when output control signal Y_{CS} and error control signal E_{CS} are single valued signals. In the case of the vector embodiment of output control signal Y_{CS}, controller 20 determines output control signal Y_{CS} is less than output control threshold Y_{THR} when the ABS of each vector element of the output control signal Y_{CS} is less than a corresponding vector element of output control threshold Y_{THR}. Otherwise, controller 20 determines output control signal Y_{CS} to be equal to or greater than output control threshold Y_{THR}, Similarly, the case of the vector embodiment of error control signal E_{CS}, controller 20 determines error control signal E_{CS} is less than error control threshold E_{THR} when the ABS of each vector element of error control signal E_{CS} is less than a corresponding vector element of error control threshold E_{THR}. Otherwise, controller 20 determines error control signal E_{CS} to be equal to or greater than error control threshold E_{THR}.

If controller 20 determines that both the ABS of the output control signal Y_{CS} is less than the output control threshold Y_{THR}, and the ABS of the error control signal E_{CS} is less than the error control threshold E_{THR}, then controller 20 proceeds to a stage S56 of flowchart 50 to set a fast dynamics flag as FALSE to indicate plant 20 is operating in a slow region of operation. If controller 20 determines that either the ABS of output control signal Y_{CS} is equal to or greater than the output control threshold Y_{THR}, or the ABS of the error control signal E_{CS} is equal to or greater than the error threshold E_{THR}, then controller 20 proceeds to a stage S58 of flowchart 50 to set the fast dynamics flag as TRUE to indicate plant 20 is operating in a fast region of operation.

Controller 20 thereafter terminates flowchart 50, and proceeds to a stage S44 of the flowchart 40 to ascertain the status of the fast dynamics flag. If the fast dynamics flag is set to FALSE, controller 20 proceeds to a stage S46 of the flowchart 40 to execute a slow dynamics control law in generating input control signal U_{CS}. If the fast dynamics flag is set to TRUE, controller 20 proceeds to a stage S48 of the flowchart 40 to execute a fast dynamics control law in generating input control signal U_{CS}. Controller 20 thereafter returns to stage S42 to repeat stages S42-S48 as needed.

The fast dynamics control law and the slow dynamics control law are dependent upon the operational specifications of plant 30 (FIG. 1). Accordingly, the laws can be discrete-time or continuous-time, time-invariant or time-varying, linear or nonlinear, and other law types as would occur to those having ordinary skill in the art. The essential distinction between a fast dynamics control law and a slow dynamics control law is a relative inclination of the fast control law to facilitate a fast yet stable reduction of the error control signal E_{CS} and any additional error control signals when the magnitude(s) of these signal(s) are relatively large.

An example form of a linear, discrete-time, fast dynamics control law is the following equation [1]:

c(k)=K*(e(k)+b₁*e(k−1)+b₂*e(k−2)) [1]

where e(k), e(k−1), and e(k−2) are error output signal E_{OS} (FIG. 1) at the present time, one loop time delayed, and two loop times delayed, respectively; c(k) is the input control signal U_{CS} (FIG. 1) at the present time; and K, b₁, b₂ are time-invariant, multiplicative coefficients.

An example form of a linear, discrete-time, slow dynamics control law is the following equation [2]

c(k)=c(k−1)+K*(e(k)+b₁*e(k−1)+b₂*e(k−2)) [2]

where c(k−1) is the input control signal U_{CS} (FIG. 1) at one loop time delayed.

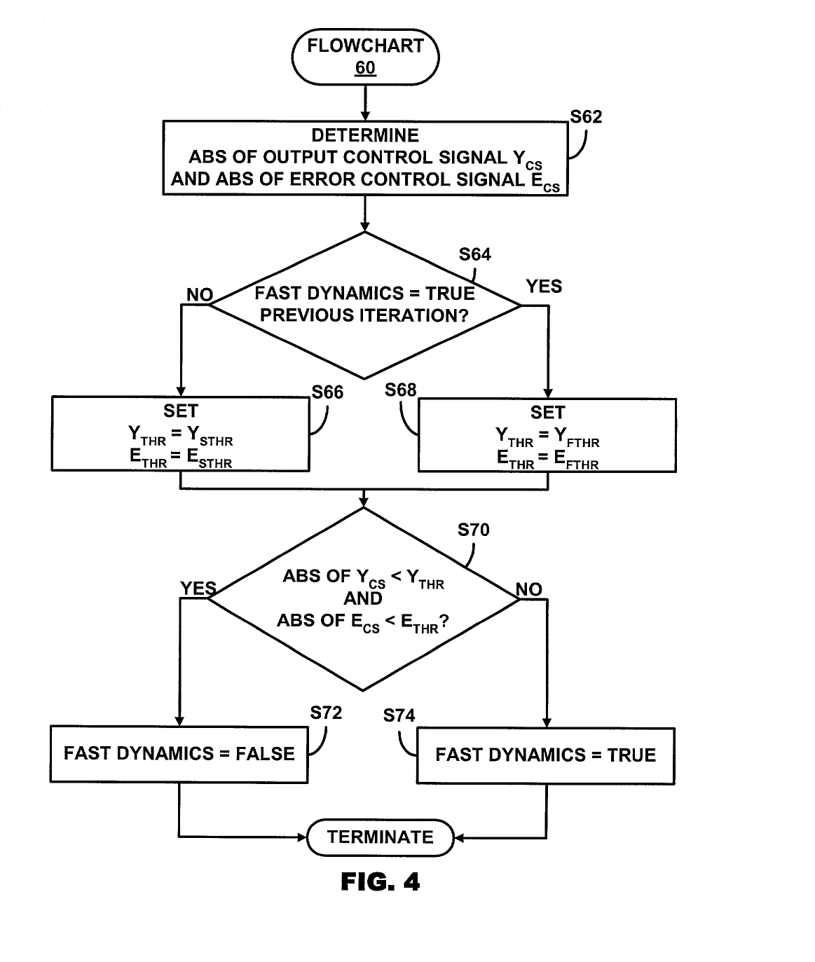

Upon a completion of a first execution of flowchart 40 (FIG. 2), controller 20 can perform subsequent executions of flowchart 40 with either an execution of flowchart 50 during stage S42 or an execution of a flowchart 60 during stage S42. FIG. 4 illustrates flowchart 60 as a representation of a second embodiment of a method of determining a system dynamics of plant 30 (FIG. 1) in accordance with the present invention.

During a stage S62 of flowchart 60, controller 20 determines the ABS of output control signal Y_{CS} and the ABS of error control signal E_{CS} as previously described in connection with stage S52 of flowchart 50 (FIG. 3). During a stage S64 of flowchart 60, controller 20 ascertains whether the fast dynamics flag was set to true during the previous execution of flowchart 40. If so, the output control threshold Y_{THR} is set to a fast control threshold value Y_{FTHR} and the error control threshold E_{THR} is set to a fast control threshold value E_{FTHR} during a stage S68 of flowchart 60. Otherwise, the output control threshold Y_{THR} is set to a slow control threshold value Y_{STHR} and the error control threshold E_{THR} is set to a slow control threshold value E_{STHR} during a stage S68 of flowchart 60.

Controller 20 thereafter proceeds to a stage S70 of flowchart 60 to ascertain whether the ABS of the output control signal Y_{CS} is less than output control threshold Y_{THR} and whether the ABS of error control signal E_{CS} is less than error threshold E_{THR} as previously described in connection with stage S54 of flowchart 50 (FIG. 3). If controller 20 determines that both the ABS of the output control signal Y_{CS} is less than the output control threshold Y_{THR}, and the ABS of the error control signal E_{CS} is less than the error control threshold E_{THR}, then controller 20 proceeds to a stage S72 of flowchart 60 to set the fast dynamics flag as FALSE to indicate plant 30 is operating in a slow region of operation. If controller 20 determines that either the ABS of output control signal Y_{CS} is equal to or greater than output control threshold Y_{THR}, or the ABS of the error control signal E_{CS} is equal to or greater than the error control threshold E_{THR}, then controller 20 proceeds to a stage S74 of flowchart 60 to set the fast dynamics flag as TRUE to indicate plant 30 is operating in a fast region of operation.

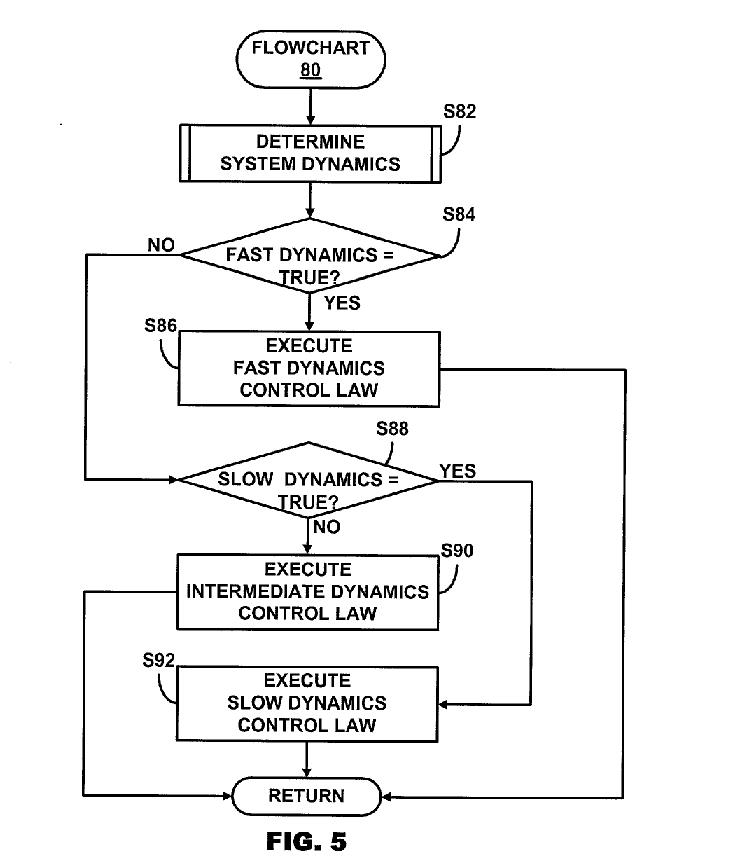

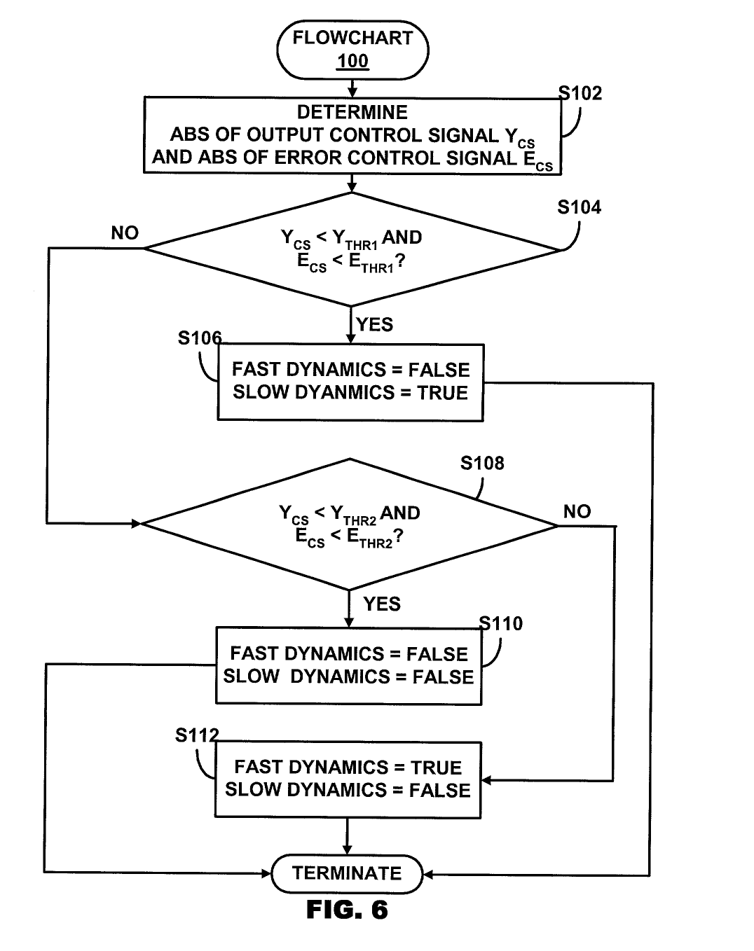

FIG. 5 illustrates a flowchart 80 as a representation of one embodiment of a tri-mode control method of the present invention. During stage S82 of the flowchart 80, controller 20 determines a system dynamics of plant 30 (FIG. 1). In one embodiment, controller 20 executes a flowchart 100 as illustrated in FIG. 6 during stage S82. Flowchart 100 is representative of a third embodiment of a method of determining a system dynamics of plant 30 in accordance with the present invention.

During a stage S102 of flowchart 100, controller 20 determines the ABS of output control signal Y_{CS} and the ABS of error control signal E_{CS} as previously described in connection with stage S52 of flowchart 50 (FIG. 3). During a stage S104 of flowchart 100, controller 20 ascertains whether the ABS of the output control signal Y_{CS} is less than output control threshold Y_{THR1} and whether the ABS of error control signal E_{CS} is less than an error control threshold E_{THR} 1 in a manner analogous to the description of stage S54 of flowchart 50 (FIG. 3) or in a manner analogous to the description of stages S64-S70 of flowchart 60 (FIG. 4). If controller 20 determines that both the ABS of the output control signal Y_{CS} is less than the output control threshold Y_{THR1}, and the absolute value of the error control signal E_{CS} is less than the error control threshold E_{THR1}, then controller 20 proceeds to a stage S106 of flowchart 100 to set the fast dynamics flag as FALSE and a slow dynamics flag as TRUE to indicate plant 30 is operating in a slow region of operation. If controller 20 determines that either the ABS of output control signal Y_{CS} is equal to or greater than the output control threshold Y_{THR1}, or the absolute value of the error control signal E_{CS} is equal to or greater than the error control threshold E_{THR1}, then controller 20 proceeds to a stage S108 of flowchart 100 to ascertain whether the ABS of the output control signal Y_{CS} is less than an output control threshold Y_{THR2} and whether the ABS of error control signal E_{CS} is less than an error threshold E_{THR2} in a manner analogous to the description of stage S54 of flowchart 50 (FIG. 3) or in a manner analogous to the description of stages S64, S66, S68, and S70 of flowchart 60 (FIG. 4).

If controller 20 determines that both the ABS of the output control signal Y_{CS} is less than the output control threshold Y_{THR2}, and the ABS of the error control signal E_{CS} is less than the error control threshold E_{THR2}, then controller 20 proceeds to a stage S110 of flowchart 100 to set the fast dynamics flag as FALSE and the slow dynamics flag as FALSE to indicate plant 30 is operating in an intermediate region of operation. If controller 20 determines that either the ABS of output control signal Y_{CS} is equal to or greater than the output control threshold Y_{THR2}, or the ABS of the error control signal E_{CS} is equal to or greater than the error control threshold E_{THR2}, then controller 20 proceeds to a stage S112 of flowchart 100 set the fast dynamics flag as TRUE and the slow dynamics flag as FALSE to indicate plant 30 is operating in a fast region of operation.

Controller 20 thereafter terminates flowchart 100, and proceeds to a stage S84 of the flowchart 80 to ascertain the status of the fast dynamics flag. If the fast dynamics flag is set to TRUE, then controller 20 proceeds to a stage S86 of the flowchart 80 to execute a fast dynamics control law in generating input control signal U_{CS}. If the fast dynamics flag is set to FALSE, then controller 20 proceeds to a stage S88 of the flowchart 80 to ascertain the status of the slow dynamics flag. If the slow dynamics flag is set to FALSE, then controller 20 proceeds to a stage S90 of the flowchart 80 to execute an intermediate dynamics control law in generating input control signal U_{CS}. If the slow dynamics flag is set to TRUE, then controller 20 proceeds to a stage S92 of the flowchart 90 to execute a slow dynamics control law in generating input control signal U_{CS}. Controller 20 thereafter returns to stage S82 to repeat stages S82-S92 as needed.

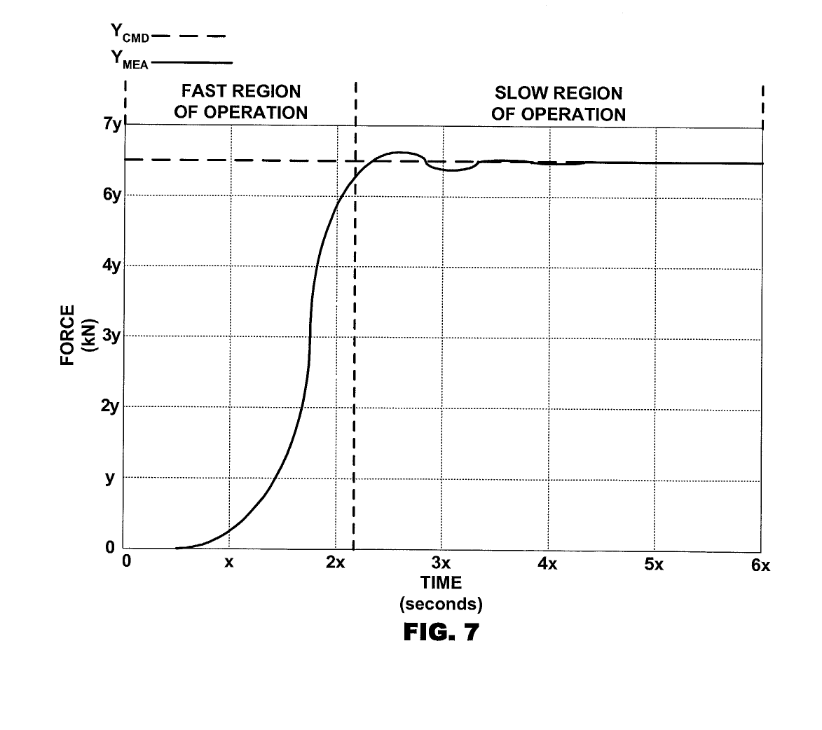

FIG. 7 illustrates an exemplary operation of the system of FIG. 1 in accordance with the present invention. Error output signal E_{OS} initially equals commanded output signal Y_{CMD}, and error output signal E_{OS} exceeds an error output threshold E_{THR} whereby the input control signal U_{CS} operates the plant in a fast dynamics region. As the measured output signal Y_{MEA} approaches the commanded output signal Y_{CMD}, both the output control signal Y_{CS} and error control signal E_{CS} decrease until both signals are less than their respective thresholds. At this point, controller 20 provides the input control signal U_{CS} to operate the plant in a slow dynamics region.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

I claim:

1. A method of providing an input control signal to a plant, comprising:
determining one or more error control signals, each error control signal being a function of one or more error output signals, each error output signal being a function of one or more measured output signals of the plant and one or more commanded output signals of the plant;
determining one or more output control signals for the first iteration, each output control signal being a function of the one or more measured output signals;
determining the input control signal as a function of a first dynamics control law when the one or more error control signals and the one or more output control signals collectively indicate the plant is operating in a first region of operation; and
determining the input control signal as a function of a second dynamics control law when the one or more error control signals and the one or more output control signals collectively indicate the plant is operating in a second region of operation.

2. The method of claim 1, further comprising:
comparing a first error control signal to an error control threshold; and
comparing a first output control signal to an output control threshold,
wherein the one or more error control signals and the one or more output control signals collectively indicate the plant is operating in a first region of operation when an absolute value of the first error control signal is less than the error control threshold and an absolute value of the first output control signal is less than the output control threshold, and
wherein the one or more error control signals and the one or more output control signals collectively indicate the plant is operating in a second region of operation when an absolute value of the first error control signal is equal to or greater than error control threshold or an absolute value of the first output control signal is equal to or greater than the output control threshold.

3. The method of claim 1, further comprising:
comparing a first error control signal having a first plurality of vector elements to an error control threshold having a second plurality of vector elements; and
comparing a first output control signal to an output control threshold,
wherein the one or more error control signals and the one or more output control signals collectively indicate the plant is operating in a first region of operation when an absolute value of each vector element of the first error control signal is less than a corresponding vector element of the error control threshold and an absolute value of the first output control signal is less than the output control threshold, and
wherein the one or more error control signals and the one or more output control signals collectively indicate the plant if operating in a second region of operation when an absolute value of one or more of the vector elements of the first error control signal is equal to or greater than corresponding vector element of the error control threshold or an absolute of the first output control signal is equal to or greater than the output control threshold.

4. The method of claim 1, further comprising:
comparing a first error control signal to an error control threshold; and
comparing a first output control signal having a first plurality of vector elements to an output control threshold having a second plurality of vector elements,
wherein the one or more error control signals and the one or more output control signals collectively indicate the plant is operating in a first region of operation when an absolute value of the first error control signal is less than the error control threshold and an absolute value of each vector element of the first output control signal is less than a corresponding vector element of the output control threshold, and
wherein the one or more error control signals and the one or more output control signals collectively indicate the plant is operating in a second region of operation when an absolute value of the first error control signal is equal to or greater than error control threshold or an absolute value of one or more of the vector elements of the first output control signal is equal to or greater than a corresponding vector element of the output control threshold.

5. The method of claim 1, further comprising:
comparing a first error control signal having a first plurality of vector elements to an error control threshold having a second plurality of vector elements; and
comparing a first output control signal having a third plurality of vector elements to an output control threshold having a fourth plurality of vector elements,
wherein the one or more error control signals and the one or more error output control signals collectively indicate the plant is operating in a first region of operation when an absolute value of each vector element of the first error control signal is less than a corresponding vector element of the error control threshold and an absolute value of each vector element of the first output control signal is less than a corresponding vector element of the output control threshold, and
wherein the one or more error control signals and the one or more output control signals collectively indicate the plant is operating in a second region of operation when an absolute value of one or more of the vector elements of the first error control signal is equal to or greater than a corresponding vector element of the error control threshold or an absolute value of one or more of the vector elements of the first output control signal is equal to or greater than a corresponding vector element of the output control threshold.

6. The method of claim 1, further comprising:
determining the input control signal as a function of a third dynamics control law when the one or more error control signals and the one or more output control signals collectively indicate the plant is operating in a third region of operation.

7. The method of claim 6, further comprising:
comparing a first error control signal to a first error control threshold; and
comparing a first output control signal to a first output control threshold,
wherein the one or more error control signals and the one or more error output control signals collectively indicate the plant is operating in a first region of operation when an absolute value of the first error control signal is less than the first error control threshold and an absolute value of the first output control signal is less than the first output control threshold.

8. The method of claim 7, further comprising:
comparing the first error control signal to a second error control threshold, the first error threshold being less than the second error control threshold; and
comparing the first output control signal to a first output control threshold, the first output threshold being less than the second output control threshold,
wherein the one or more error control signals and the one or more output control signals collectively indicate the plant is operating in a second region of operation when an absolute value of the first error control signal is equal to or greater than the first error control threshold and less than the second error control threshold and an absolute value of the first output control signal is less than the second output control threshold, or when an absolute value of the first error control signal is less than the second error control threshold and an absolute value of the first output control signal is equal to or greater than the first output control threshold and is less than the second output control threshold, and
wherein the one or more error control signals and the one or more output control signals collectively indicate the plant is operating in a third region of operation when an absolute value of the first error control signal is equal to or greater than second error control threshold or an absolute value of the first output control signal is equal to or greater than the second output control threshold.

9. The method of claim 6, further comprising:
comparing a first error control signal having a first plurality of vector elements to a first error control threshold having a second plurality of vector elements; and
comparing a first output control signal to a first output control threshold,
wherein the one or more error control signals and the one or more error output control signals collectively indicate the plant is operating in a first region of operation when an absolute value of each vector element of the first error control signal is less than the corresponding vector element of the first error control threshold and an absolute value of the first output control signal is less than the first output control threshold.

10. The method of claim 9, further comprising:
comparing the first error control signal to a second error control threshold having a third plurality of vector elements, each vector element of the first error threshold being less than a corresponding vector element of the second error control threshold; and
comparing the first output control signal to a first output control threshold, the first output threshold being less than the second output control threshold,
wherein the one or more error control signals and the one or more output control signals collectively indicate the plant is operating in a second region of operation when an absolute value of one or more vector elements of the first error control signal is equal to or greater than a corresponding vector element of the first error control threshold and each vector element is less than a corresponding vector element of the second error control threshold and an absolute value of the first output control signal is less than the second output control threshold, or when an absolute value of each vector element of the first error control signal is less than the corresponding vector element of the second error control threshold and an absolute value of the first output control signal is equal to or greater than the first output control threshold and is less than the second output control threshold, and
wherein the one or more error control signals and the one or more output control signals collectively indicate the plant is operating in a third region of operation when an absolute value of one or more vector elements of the first error control signal is equal to or greater than the corresponding vector element of the second error control threshold or an absolute value of the first output control signal is equal to or greater than the second output control threshold.

11. The method of claim 6, further comprising:
comparing a first error control signal to a first error control threshold; and
comparing a first output control signal having a first plurality of vector elements to a first output control threshold having a second plurality of vector elements,
wherein the one or more error control signals and the one or more error output control signals collectively indicate the plant is operating in a first region of operation when an absolute value of the first error control signal is less than the first error control threshold and an absolute value of each vector element of the first output control signal is less than a corresponding vector element of the first output control threshold.

12. The method of claim 11, further comprising:
comparing the first error control signal to a second error control threshold, the first error threshold being less than the second error control threshold; and
comparing the first output control signal to a second output control threshold having a third plurality of vector elements, each vector element of the first output threshold being less than a corresponding vector element of the second output control threshold,
wherein the one or more error control signals and the one or more output control signals collectively indicate the plant is operating in a second region of operation when an absolute value of the first error control signal is equal to or greater than the first error control threshold and less than the second error control threshold and an absolute value of each vector element of the first output control signal is less than a corresponding vector element of the second output control threshold, or when an absolute value of the first error control signal is less than the second error control threshold and an absolute value of one or more vector elements of the first output control signal is equal to or greater than a corresponding vector element of the first output control threshold and each vector element is less than the corresponding vector element of the second output control threshold, and
wherein the one or more error control signals and the one or more output control signals collectively indicate the plant is operating in a third region of operation when an absolute value of the first error control signal is equal to or greater than second error control threshold or an absolute value of one or more vector elements of the first output control signal is equal to or greater than the corresponding vector element of the second output control threshold.

13. The method of claim 6, further comprising:
comparing a first error control signal having a first plurality of vector elements to a first error control threshold having a second plurality of vector elements; and
comparing a first output control signal having a third plurality of vector elements to a first output control threshold having a fourth plurality of vector elements,
wherein the one or more error control signals and the one or more error output control signals collectively indicate the plant is operating in a first region of operation when an absolute value of each vector element of the first error control signal is less than a corresponding vector element of the first error control threshold and an absolute value of each vector element of the first output control signal is less than a corresponding vector element of the first output control threshold.

14. The method of claim 13, further comprising:
comparing the first error control signal to a second error control threshold having a fifth plurality of vector elements, each vector element of the first error threshold being less than a corresponding vector element of the second error control threshold; and
comparing the first output control signal to a first output control threshold having a sixth plurality of vector elements, each vector element of the first output threshold being less than a corresponding vector element of the second output control threshold,
wherein the one or more error control signals and the one or more output control signals collectively indicate the plant is operating in a second region of operation when an absolute value of one or more vector elements of the first error control signal is equal to or greater than the corresponding vector element of the first error control threshold and each vector element is less than the corresponding vector element of the second error control threshold and an absolute value of each vector element of the first output control signal is less than the corresponding vector element of the second output control threshold, or when an absolute value of each vector element of the first error control signal less than the corresponding vector element of the second error control threshold and an absolute value of one or more vector elements of the first output control signal is equal to or greater than the corresponding vector element of the first output control threshold and each vector elements is less than the corresponding vector element of the second output control threshold, and
wherein the one or more error control signals and the one or more output control signals collectively indicate the plant is operating in a third region of operation when an absolute value of one or more vector elements of the first error control signal is equal to or greater than the corresponding vector element of the second error control threshold or an absolute value of one or more vector elements of the first output control signal is equal to or greater than the corresponding vector element of the second output control threshold.

15. A system, comprising:
a plant operable to provide one or more measured output signals in response to a reception of an input control signal; and
a controller,
wherein said controller is operable to determine one or more error control signals, each error control signal being a function of one or more error output signals, each error output signal being a function of one or more measured output signals of the plant and one or more commanded output signals of the plant,
wherein said controller is operable to determine one or more output control signals for the first iteration, each output control signal being a function of the one or more measured output signals,
wherein said controller is further operable to determine the input control signal as a function of a first dynamics control law when the one or more error control signals and the one or more output control signals collectively indicate the plant is operating in a first region of operation, and
wherein said controller is further operable to determine the input control signal as a function of a second dynamics control law when the one or more error control signals and the one or more output control signals collectively indicate the plant is operating in a second region of operation.

16. The system of claim 15, wherein:
said controller is further operable to compare a first error control signal to an error control threshold;
said controller is further operable to compare a first output control signal to an output control threshold;
the one or more error control signals and the one or more output control signals collectively indicate the plant is operating in a first region of operation when an absolute value of the first error control signal is less than the error control threshold and an absolute value of the first output control signal is less than the output control threshold; and
the one or more error control signals and the one or more output control signals collectively indicate the plant if operating in a second region of operation when an absolute value of the first error control signal is equal to or greater than error control threshold or an absolute value of the first output control signal is equal to or greater than the output control threshold.

17. The system of claim 15, wherein:
said controller is further operable to compare a first error control signal having a first plurality of vector elements to an error control threshold having a second plurality of vector elements;
said controller is further operable to compare a first output control signal to an output control threshold;
the one or more error control signals and the one or more output control signals collectively indicate the plant is operating in a first region of operation when an absolute value of each vector element of the first error control signal is less than the corresponding element of the error control threshold and an absolute value of the first output control signal is less than the output control threshold; and
the one or more error control signals and the one or more output control signals collectively indicate the plant is operating in a second region of operation when an absolute value of one or more of the vector elements of the first error control signal is equal to or greater than the corresponding element of the error control threshold or an absolute value of the first output control signal is equal to or greater than the corresponding element of the vector output control threshold.

18. The system of claim 15, wherein:
said controller is further operable to compare a first error control signal to an error control threshold;
said controller is further operable to compare a first output control signal having a first plurality of vector elements to an output control threshold having a second plurality of vector elements;
the one or more error control signals and the one or more output control signals collectively indicate the plant is operating in a first region of operation when an absolute value of the first error control signal is less than the error control threshold and an absolute value of each vector element of the first output control signal is less than a corresponding vector element of the output control threshold; and
the one or more error control signals and the one or more output control signals collectively indicate the plant is operating in a second region of operation when an absolute value of the first error control signal is equal to or greater than error control threshold or an absolute value of one or more of the vector elements of the first output control signal is equal to or greater than the corresponding vector element of the output control threshold.

19. The system of claim 15, wherein:
said controller is further operable to compare a first error control signal having a first plurality of vector elements to an error control threshold having a second plurality of vector elements;
said controller is further operable to compare a first output control signal having a third plurality of vector elements to an output control threshold having a fourth plurality of vector elements;
the one or more error control signals and the one or more error output control signals collectively indicate the plant is operating in a first region of operation when an absolute value of each vector element of the first error control signal is less than a corresponding element of the error control threshold and an absolute value of each vector element of the first output control signal is less than a corresponding element of the output control threshold; and
the one or more error control signals and the one or more output control signals collectively indicate the plant is operating in a second region of operation when an absolute value of one or more of the vector elements of the corresponding vector element of the first error control signal is equal to or greater than the corresponding element of the error control threshold or an absolute value of one or more of the vector elements of the first output control signal is equal to or greater than the corresponding element of the output control threshold.

20. The system of claim 15, wherein:
said controller is further operable to determine the input control signal as a function of a third dynamics control law when the one or more error control signals and the one or more output control signals collectively indicate the plant is operating in a third region of operation.

21. The system of claim 20, wherein:
said controller is further operable to compare a first error control signal to a first error control threshold;
said controller is further operable to compare a first output control signal to a first output control threshold; and
the one or more error control signals and the one or more error output control signals collectively indicate the plant is operating in a first region of operation when an absolute value of the first error control signal is less than the first error control threshold and an absolute value of the first output control signal is less than the first output control threshold.

22. The system of claim 21, wherein:
said controller is further operable to compare the first error control signal to a second error control threshold, the first error threshold being less than the second error control threshold;
said controller is further operable to compare the first output control signal to a first output control threshold, the first output threshold being less than the second output control threshold;
the one or more error control signals and the one or more output control signals collectively indicate the plant is operating in a second region of operation when an absolute value of the first error control signal is equal to or greater than the first error control threshold and less than the second error control threshold and an absolute value of the first output control signal is than the second output control threshold, or when an absolute value of the first error control signal is less than the second error control threshold and an absolute value of the first output control signal is equal to or greater than the first output control threshold and is less than the second output control threshold; and
the one or more error control signals and the one or more output control signals collectively indicate the plant is operating in a third region of operation when an absolute value of the first error control signal is equal to or greater than second error control threshold or an absolute value of the first output control signal is equal to or greater than the second output control threshold.

23. The system of claim 20, wherein:
said controller is further operable to compare a first error control signal having a first plurality of vector elements to a first error control threshold having a second plurality of vector elements;
said controller is further operable to compare a first output control signal to a first output control threshold; and
the one or more error control signals and the one or more error output control signals collectively indicate the plant is operating in a first region of operation when an absolute value of each vector element of the first error control signal is less than a corresponding element of the first error control threshold and an absolute value of the first output control signal is less than the first output control threshold.

24. The system of claim 23, wherein:
said controller is further operable to compare the first error control signal to a second error control threshold having a third plurality of vector elements, each vector element of the first error threshold being less than a corresponding vector element of the second error control threshold;
said controller is further operable to compare the first output control signal to a first output control threshold, the first output threshold being less than the second output control threshold;
the one or more error control signals and the one or more output control signals collectively indicate the plant is operating in a second region of operation when an absolute value of one or more vector elements of the first error control signal is equal to or greater than the corresponding element of the first error control threshold and the absolute value of each vector element of the first error control signal is less than the corresponding elements of the second error control threshold and an absolute value of the first output control signal is less than the second output control threshold, or when an absolute value of each vector element of the first error control signal is less than the corresponding element of the second error control threshold and an absolute value of the first output control signal is equal to or greater than the first output control threshold and is less than the second output control threshold; and
the one or more error control signals and the one or more output control signals collectively indicate the plant is operating in a third region of operation when an absolute value of one or more vector elements of the first error control signal is equal to or greater than the corresponding element of the second error control threshold or an absolute value of the first output control signal is equal to or greater than the second output control threshold.

25. The system of claim 20, wherein:
said controller is further operable to compare a first error control signal to a first error control threshold;
said controller is further operable to compare a first output control signal having a first plurality of vector elements to a first output control threshold having a second plurality of vector elements; and
the one or more error control signals and the one or more error output control signals collectively indicate the plant is operating in a first region of operation when an absolute value of the first error control signal is less than the first error control threshold and an absolute value of each vector element of the first output control signal is less than a corresponding vector element of the first output control threshold.

26. The system of claim 25, wherein:
said controller is further operable to compare the first error control signal to a second error control threshold, the first error threshold being less than the second error control threshold;
said controller is further operable to compare the first output control signal to a second output control threshold having a third plurality of vector elements, each vector element of the first output threshold being less than a corresponding vector element of the second output control threshold;
the one or more error control signals and the one or more output control signals collectively indicate the plant is operating in a second region of operation when an absolute value of the first error control signal is equal to or greater than the first error control threshold and less than the second error control threshold and an absolute value of one or more vector elements of the first output control signal is equal to or greater than a corresponding element of the first output control threshold and an absolute value of each vector element of the first output control signal is less than the corresponding vector element of the second output control threshold, or when an absolute value of the first error control signal is less than the second error control threshold and an absolute value of one or more vector elements of the first output control signal is equal to or greater than the corresponding vector element of the first output control threshold and an absolute value of each vector element of the first output control signal is less than the corresponding vector element of the second output control threshold; and
the one or more error control signals and the one or more output control signals collectively indicate the plant if operating in a third region of operation when an absolute value of the first error control signal is equal to or greater than second error control threshold or an absolute value of each vector element of the first output control signal is equal to or greater than the corresponding vector element of the second output control threshold.

27. The system of claim 20, wherein:
said controller is further operable to compare a first error control signal having a first plurality of vector elements to a first error control threshold having a second plurality of vector elements;
said controller is further operable to compare a first output control signal having a third plurality of vector elements to a first output control threshold having a fourth plurality of vector elements; and
the one or more error control signals and the one or more error output control signals collectively indicate the plant is operating in a first region of operation when an absolute value of each vector element of the first error control signal is less than a corresponding vector element of the first error control threshold and an absolute value of each vector element of the first output control signal is less than a corresponding vector element of the first output control threshold.

28. The system of claim 27, wherein:
said controller is further operable to compare the first error control signal to a second error control threshold having a fifth plurality of vector elements, each vector element of the first error threshold being less than a corresponding vector element of the second error control threshold;
said controller is further operable to compare the first output control signal to a second output control threshold having a sixth plurality of vector elements, each vector element of the first output threshold being less than a corresponding vector element of the second output control threshold;
the one or more error control signals and the one or more output control signals collectively indicate the plant is operating in a second region of operation when an absolute value of one or more vector elements of the first error control signal is equal to or greater than the corresponding vector element of the first error control threshold and each vector element of the first error control signal is less than the corresponding vector element of the second error control threshold and an absolute value of each vector element of the first output control signal is less than the corresponding vector element of the second output control threshold, or when an absolute value of each vector element of the first error control signal is less than the corresponding vector element of the second error control threshold and each vector element of the first output control signal is less than the corresponding vector element of the second error control threshold and an absolute value of one or more vector elements of the first output control signal is equal to or greater than the corresponding vector element of the first output control threshold; and
the one or more error control signals and the one or more output control signals collectively indicate the plant is operating in a third region of operation when an absolute value of one or more vector elements of the first error control signal is equal to or greater than the corresponding vector element of the second error control threshold or an absolute value of one or more vector elements of the first output control signal is equal to or greater than the corresponding vector element of the second output control threshold.
